(19) United States
(12) Patent Application Publication
(10) Pub. No.: US 2008/0190019 A1
(43) Pub. Date: Aug. 14, 2008

(54) Plant support system and method

(76) Inventor: Robert S. Hart, Bradford, PA (US)

Correspondence Address: BERENATO, WHITE & STAVISH, LLC, 6550 ROCK SPRING DRIVE, SUITE 240, BETHESDA, MD, 20817, US

(21) Appl. No.: 11/704,266

(22) Filed: Feb. 9, 2007

(51) Int. Cl. A01G 17/14

(52) U.S. Cl. 47/47

(57) ABSTRACT

The present invention relates to a plant support system having a central post, at least first and second cross pieces, and a plurality of strings. The central post has a first end disposed in the ground and an opposite second end. The cross pieces extend outwardly from the central post second end. Each of the cross pieces has a first end releaseably securable to the central post second end and a second distal end. Each of the strings is securable to a corresponding one of the cross pieces. A plant growing proximate the central post is attachable to a corresponding one of the strings as the plant grows upwardly. The present invention also relates to a method of supporting growing plants.

### FIELD OF THE INVENTION

The present invention relates to a plant support system having a central post, at least first and second cross pieces, and a plurality of strings. The central post has a first end disposed in the ground and an opposite second end. The cross pieces extend outwardly from the central post second end. Each of the cross pieces has a first end releaseably securable to the central post second end and a second distal end. Each of the strings is securable to a corresponding one of the cross pieces. A plant growing proximate the central post is attachable to a corresponding one of the strings as the plant grows upwardly. The present invention also relates to a method of supporting growing plants.

### BACKGROUND OF THE INVENTION

Proper plant growth for most cultivated crops requires sufficient sunlight, nutrients, and water, as well as an adequate growing season and growing area. In addition, many cultivated plants require assistance and support in maintaining the continuous upward growth of their stalks and stems. As the stalks grow upward from the soil, their respective maturing fruits or vegetables, along with the upper part of the plant stalk, may bend the plant to the ground before optimal maturation. The plant may continue to grow along the ground, but farther growth particularly of the fruits or vegetables may be hampered due to a lack of adequate sunlight and growing space.

Moreover, if the stalk and fruits or vegetables are growing along the ground, the possibility of fungal disease and decay is substantially increased due to ground moisture, as well as ground dwelling insects, rodents and other pests. The yield and quality of fruit and vegetables is often decreased due to such conditions, and may ultimately result in the death of the plant before the maturation process is complete.

Various attempts have been made to support and maintain the upward growth of plants. Some conventional designs provide for either stakes or lattice work supports to support the plants. Such structures are secured in the ground next to the plants. As the plant grows, a gardener continues to tie or clamp the growing plant to the stake or support at various points. However, such designs are time consuming and therefore relatively inefficient.

Other designs provide for wire mesh cages in which the plant grows. Again, the gardener must continue to tie the plant to the mesh cage. Moreover, the cage may need to be replaced with a larger cage as the plant grows, which may be difficult given the leaves and/or produce from the growing plant typically becomes enmeshed with the cage. Thus, the size of the cage is important for such designs. If the cage is too large, no support is provided. If the cage is too small, plant growth is hampered.

In both stake and lattice-type designs, as well as cage designs, the support to which the growing plant is attached is in a fixed position. The gardener typically engages as few clamps or ties as possible in order to save time. This increases the pressure at the points of engagement on the plant. Indeed, the clamps or ties may cut into the plant as the plant grows if such clamps or ties are not loosened or removed, given the ties and clamps are attached to the fixed support.

Therefore, there is a need for a plant support system that overcomes some or all of the above-noted problems.

### SUMMARY OF THE INVENTION

The present invention relates to a plant support system having a central post, at least first and second cross pieces, and a plurality of strings. The central post has a first end disposed in the ground and an opposite second end. The cross pieces extend outwardly from the central post second end. Each of the cross pieces has a first end releaseably securable to the central post second end and a second distal end. Each of the strings is securable to a corresponding one of the cross pieces. A plant growing proximate the central post is attachable to a corresponding one of the strings as the plant grows upwardly.

The present invention also relates to a method of supporting growing plants. A plant support system is provided having a central post having a first end and an opposite second, a plurality of cross pieces extending outwardly from the central post second end, and a string secured to each cross piece and extending downwardly therefrom. A plurality of clips is also provided. The central post first end is inserted into the ground intermediate and adjacent at least two plants. A portion of one of the plants is attached to a fixed position on one string via one of the clips. A portion of another of the plants is attached to a fixed position on another string via another of the clips. Upward growth of the plants is supported and maintained by continuously attaching additional portions of the plants to the corresponding strings via additional clips.

### BRIEF DESCRIPTION OF THE DRAWINGS

FIG. 1 is a perspective view of a plant support system according to the present invention;

FIG. 2 is a fragmentary bottom view of a cross piece of the plant support system of FIG. 1;

FIG. 3 is a side view of the cross piece of FIG. 2;

FIG. 4 is a perspective view of cross pieces of the plant support system of FIG. 1;

FIG. 5 is an exploded fragmentary view of showing a plant clipped to a string in accordance with the plant support system of the present invention;

FIG. 6 is a perspective view of a plant clip suitable for use with the plant support system of the present invention;

FIG. 7 is an elevational view of a plant hook suitable for use with the plant support system of the present invention; and

FIG. 8 is a perspective view of a plant support system according to another embodiment.

### DETAILED DESCRIPTION OF THE PREFERRED EMBODIMENTS

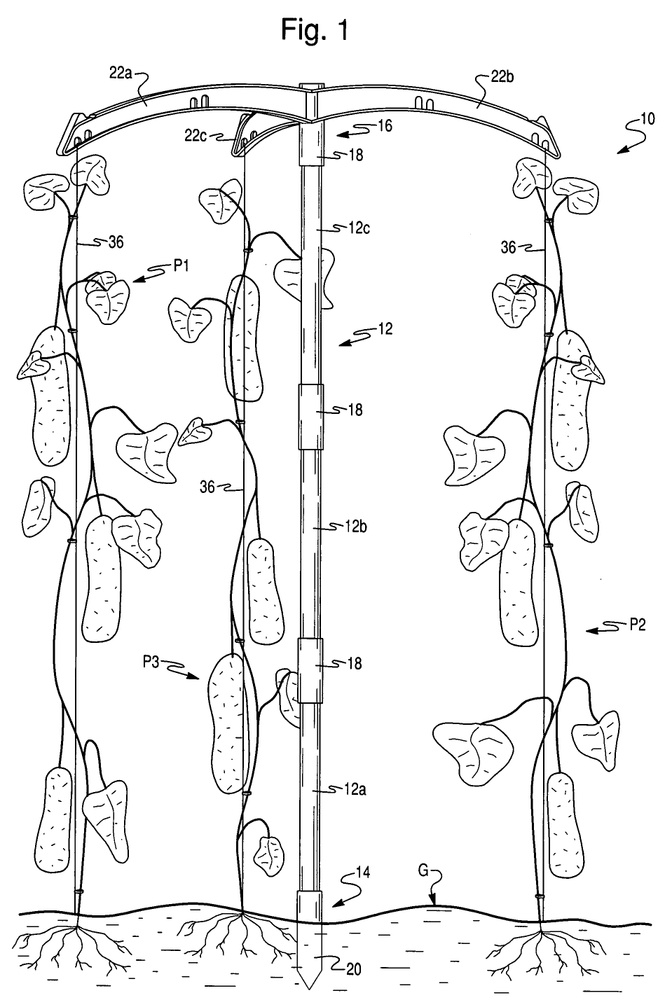

A plant support system 10 according to an embodiment of the present invention is best shown in FIG. 1. System 10 includes a central post 12 having a first end 14 and an opposite second end 16. In use, first end 14 is disposed in the ground G. Central post 12 may include a plurality of rods 12a, 12b, 12c, which are releaseably attached together and axially aligned. Any number of rods 12a, 12b and/or 12c may be provided depending on the desired height of central post 12. Further, the specific length of each rod 12a, 12b and/or 12c may vary depending on the desired overall height of central post 12. For example, each of rods 12a, 12b, 12c may have a length of between about 1 foot and about 3 feet, more preferably about 2 feet. It should be understood, however, that central post 12 may also comprise a single rod having a desired length.

Adjacent rods 12a, 12b or 12c may be releaseably attached via a corresponding collar 18. Collar 18 may be fixedly secured to one of rods 12a, 12b, with a corresponding end of the adjacent rod 12b, 12c inserted into a bore formed by the distal end of collar 18. In this way, central post 12 may be easily assembled or disassembled. Alternatively, adjacent rods may include swedged ends, which may be releaseably attached together, instead of using collars 18.

An end cap 20 may be provided on the bottommost rod 12a, which is intended for insertion into the ground G. End cap 20 may include a pointed distal end for easy insertion into the ground G. Note that a deep insertion of central post 12 into the ground G is not required. Rather, upright balance of central post 12 is maintained by adjacent plants supported by system 10, explained in detail below. Central post 12 may be inserted into the ground G a sufficient depth such that central post 12 does not lean or fall over when a user releases central post 12 after insertion into the ground G. For example, central post may be inserted into the ground G between about 6 to 10 inches.

Preferably, rods 12a, 12b, 12c are formed for a rot-resistant material, such as a polymer composite, metal, or a rot-resistant wood. For example, rods 12a, 12b, 12c may be formed from polymer composite, aluminum tubing, or welded cold rolled steel. Likewise, collars 18 and/or end cap 20 are preferably formed from a polymer composite, such as by injection molding, or from a metal, or a rot-resistant wood.

System 10 also includes a plurality of cross pieces 22a, 22b, 22c extending outwardly from second end 16 of central post 12, as shown in FIGS. 1-3. Cross pieces 22a, 22b, 22c are preferably formed from a rot-resistant material, such as a polymer composite, metal, or a rot-resistant wood. For example, cross pieces 22a, 22b, 22c may be formed by injection molding, or from cast aluminum or steel. One skilled in the art would appreciate that various materials could be used to form the various components of the present invention. Cross piece 22a has a first end 24, which is releaseably securable to second end 16 of central post 12, and an opposite second distal end 26, as best shown in FIG. 3. Preferably, first end 24 includes a projection 28 configured for being received in the corresponding bore formed by collar 18 associated with uppermost rod 12c, as shown in FIG. 1. Cross pieces 22b, 22c are similarly configured.

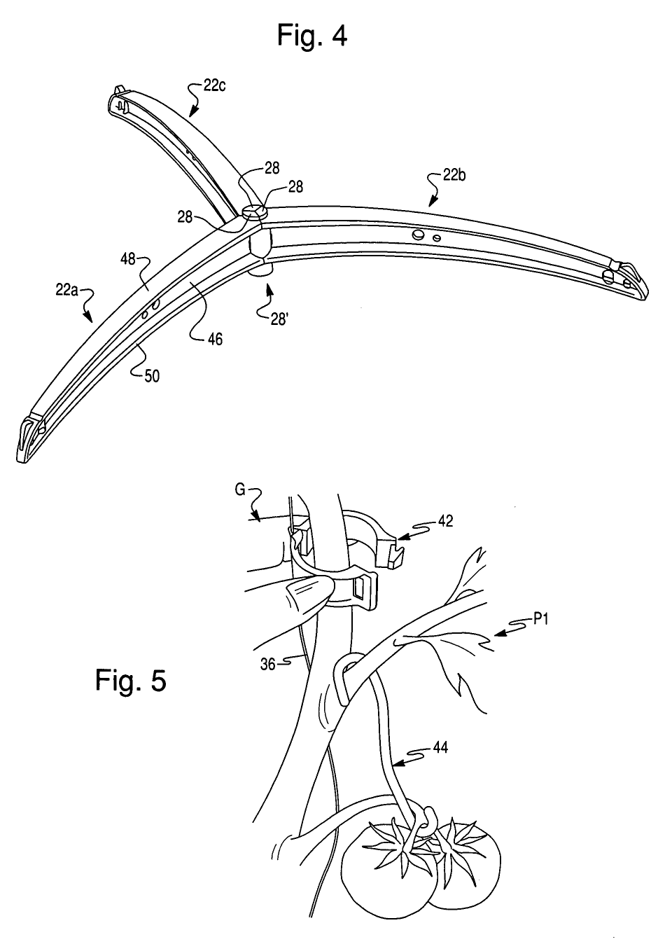

As best shown in FIG. 4, projections 28 of cross pieces 22a, 22b, 22c preferably fit together and fit within the corresponding bore of collar 18. Projections 28 of cross pieces 22a, 22b, 22c align with each other in a cylindrical configuration 28′ that is received in the corresponding bore of collar 18. The bore of collar 18 is therefore sized and configured for receiving a desired number of projections 28. Accordingly, the precise dimensions and configurations of projections 28 and collar 18 may vary depending on the number of cross pieces being used.

Referring again to FIGS. 1-3, each of cross pieces 22a, 22b, 22c preferably includes one or more openings 30a, 30b extending between and through sides 32, 34. One of more strings 36 may be secured to each cross piece 22a, 22b, 22c, as shown in FIG. 1.

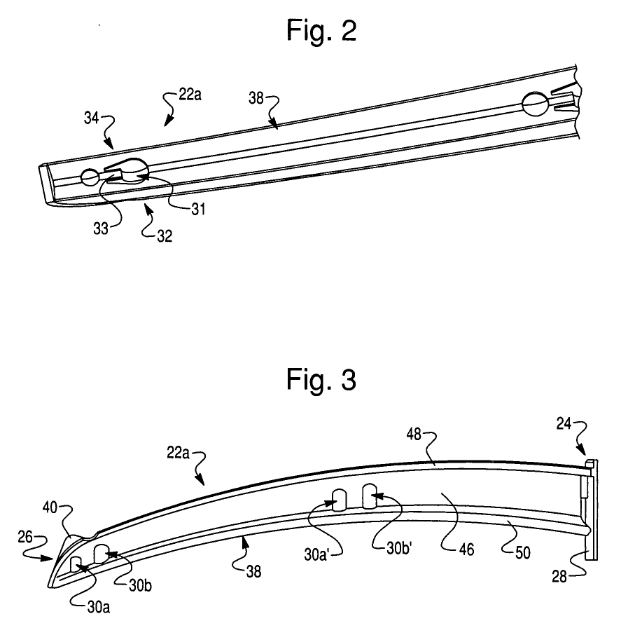

As shown in FIG. 2, a recess 31 may extend into an underside 38 of cross piece 22a (or 22b, 22c). A tab 33 extends outwardly into recess 31. The gardener may secure the free end of string 36 to cross piece 22a (or 22b, 22c) by looping the free end of string 36 through opening 30a, and then into and back through opening 30b. Alternatively, the ends of each of strings 36 may include a pre-attached aglet, such as a piece of plastic. By tying a knot at the ends of strings 36, or by using aglets, each string 36 may be wedged between a slit formed by tab 33 and recess 31. In this way, string 36 is easily secured to second distal end 26, and prevented from sliding off cross piece 22a (or 22b, 22c).

Second distal end 26 of each cross piece 22a, 22b, 22c may also include a flange 40 extending upwardly therefrom. As the plant grows to a length and height exceeding the height of central post 12, the end of the growing plant may be looped over cross piece 22a (or 22b, 22c). Flange 40 prevents the end of the plant from easily sliding off of cross piece 22a (or 22b, 22c). In addition, string 36 may be simply looped over and around cross piece 22a (or 22b, 22c), and maintained thereon due to flange 40, thereby eliminating the need for openings 30a, 30b. However, the ends of strings 36 should be securely fixed to cross pieces 22a, 22b, 22c.

Each cross piece 22a, 22b, 22c may include additional openings 30a′, 30b′ spaced from openings 30a, 30b, and intermediate first and second ends 24, 26. Depending on the position of growing plants P relative to central post 12, the gardener may select whichever openings 30a, 30b or 30a′, 30b′ are best aligned with the growing plants P.

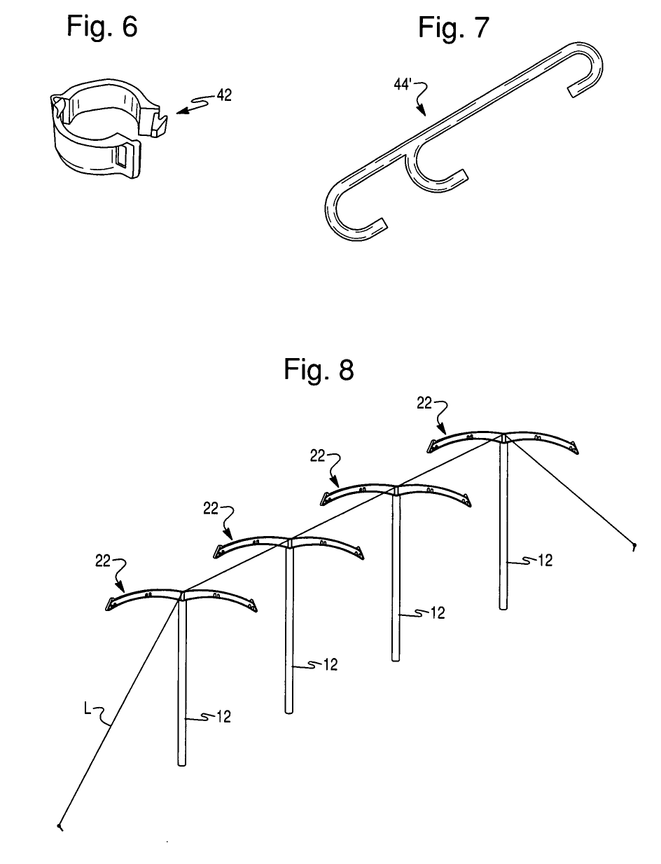

Referring again to FIG. 1, a plant P1 growing proximate central post 12 is attached to a corresponding string 36 secured to and hanging from cross piece 22a. A gardener G may releasably secure plant P1 to string 36 at a selected position via plant clips 42, as shown in FIGS. 1, 5 and 6. As plant P1 grows upwardly, the gardener continues to secure a portion of plant P1 to string 36, thereby maintaining support for the upward growth of plant P1. Likewise, plants P2, P3 are releaseably secured to strings 36 secured to and hanging from cross pieces 22b, 22c. Plant clips 42 loosely clamp around a portion of plants P1, P2, P3, and are removable yet fixedly secured at a selected position on a corresponding string 36. In this way, clips 42 do not slide down strings 36. Given each of plants P1, P2, P3 is secured to a corresponding string 36, the weight and downward force of one of plants P1, P2, or P3 (due to gravity) imparts an upward pull on the other strings 36. Thus, the weight from all plants P1, P2, P3 maintains central post 12 in an upward position. In addition, because the plants P1, P2, P3 are secured to strings 36, upward growth will not be hampered, as it may be when plants are secured to a fixed stake, given strings 36 are flexible and therefore do not restrain upward growth of the plants.

Central post 12 need not be driven into the ground very deep to maintain its upright positioning, compared to conventional support devices. For example, conventional support stakes must be driven into the ground to a sufficient depth, such as one third of the length of the stake, in order to maintain upright positioning because it is the stake itself that supports the plant. Therefore, a conventional six foot stake is typically inserted into the ground 2 feet, given it must support all of the weight and forces exerted by the growing plant.

In contrast, central post 12 of the present invention is used primarily to support and position cross pieces 22a, 22b, 22c. Therefore, it need only be inserted into the ground G to a depth sufficient such that it does not fall over after insertion, for example, 6 to 10 inches into the ground G. Plants P1, P2, P3 supported by strings 36 pull against and counterbalance each other, thereby stabilizing upward growth of all plants P1, P2, P3. In addition, the downward force of all plants P1, P2, P3, due to gravitational forces, stabilizes the upright positioning of central post 12.

Preferably, each cross piece 22a, 22b, 22c has an arcuate configuration, curving downward slightly. The arcuate configuration helps to transfer the downward force from plants P1, P2, P3 to the second distal end 26. In addition, the arcuate configuration enhances the structural integrity of cross pieces 22a, 22b, 22c. As best shown in FIGS. 3 and 4, cross pieces 22a, 22b, 22c preferably have a “I” configuration in section, including a central portion 46 disposed between and integrally formed with upper and lower portions 48, 50. Central portion 46 preferably lies on a plane substantially perpendicular to upper and lower portions 48, 50, thereby forming the “I” configuration in section. Such a configuration provides adequate structural support required for maintaining the weight of growing plants P1, P2, P3, which exert a downward force via strings 36 as described above.

One or more plant support hooks 44, shown in FIG. 5, may also be used to help support branches of plants P1, P2, P3. As known in the art, hooks 44 may be used to support the weight of adjacent branches of a growing plant, particularly branches bearing vegetables such as tomatoes, cucumbers, egg plants, or other vegetables, such may cause undue stress on the branch and/or central stalk of the growing plant. Plant support hooks having other configurations may also be used, such as plant support hooks 44′ shown in FIG. 7, which similarly support the weight of adjacent branches and particularly branches bearing fruit or vegetables.

The present invention also relates to a method of supporting growing plants. Plant support system 10 is provided, having central post 12, cross pieces 22a, 22b, 22c, and a plurality of strings 36 and clips 42, as described above. Central post 12 is inserted into the ground G a sufficient distance such that, when the user releases central post 12, it is maintained in a generally upright position intermediate and adjacent growing plants P1, P2, P3. A portion of each of plants P1, P2, P3 is secured to corresponding strings 36 via clips 42. Upward growth of plants P1, P2, P3 is supported and maintained by continuously attaching additional portions of the plants to corresponding strings 36 via additional clips 42 as the plants grow. The weight from all plants P1, P2, P3 maintains central post 12 in an upward position. Because the plants P1, P2, P3 are secured to strings 36, upward growth will not be hampered, given strings 36 are flexible and therefore do not restrain upward growth of the plants. Moreover, the weight and downward force of one of plants P1, P2, or P3 (due to gravity) imparts an upward pull on the other strings 36, thereby maintaining central post 12 in an upright position.

The disclosed plant support system reduces the amount of space required for growing plants, particularly plants that need to be staked or supported due to the weight of the fruit thereon. Air circulation is improved, as well as exposure to sunlight, thereby maximizing growing conditions and minimizing rot from moisture. Moreover, the plants are kept off the ground, thereby minimizing damage due to ground dwelling insects. The disclosed support system may be used on large-scale agricultural tracts, or small-scale gardens by ‘back yard’ gardeners. The weight of plants is supported, allowing for upward growth. However, such upward growth is not hampered given the plants are secured to flexible strings, and supported by each other as opposed to a central stake.

It may be desirable for some crops to provide only first and second cross pieces extending outwardly from second end 16 of central post 12. In an alternative embodiment, two cross pieces 22 extend outwardly from second end 16 of central post 12, as shown in FIG. 8, with the corresponding two projections (corresponding to projection 28) modified to fit within the corresponding bore on collar 18. Such a configuration may be appropriate for supporting particular plants that are planted in rows, such as grape vines. Additional support may be provided by extending a line L, preferably a rot-resistant twine or rope, or a metal line, between adjacent central posts 12 within a given row. The line may then be anchored in the ground G following the end central posts 12 in the row, thereby providing additional support for the entire row of central posts 12.

Alternatively, four or more cross pieces may be provided extending outwardly from central post 12. However, three or more cross pieces provide optimal balance for central post 12 for many plants, such as tomatoes, cucumbers, egg plants, squash, melons, peas, pole beans, and the like. However, an additional support line may be provided, as described above and shown in FIG. 8, if only two cross pieces are desired for the particular plants to be grown.

The disclosed support system may be easily assembled and disassembled without the need for any bolts, screws, or other fasteners. As such, no tools are required for assembly or disassembly.

It will be apparent to one of ordinary skill in the art that various modifications and variations can be made in construction or configuration of the present invention without departing from the scope or spirit of the invention. Thus, it is intended that the present invention cover any such modifications and variations, and as may be applied to the central features set forth above, provided they come within the scope of the following claims and their equivalents.

I claim:

1. A plant support system, comprising:
a central post having a first end disposed in the ground and an opposite second end;
at least first and second cross pieces extending outwardly from said central post second end, each of said cross pieces having a first end releaseably securable to said central post second end and a second distal end;
a plurality of strings, each of said strings securable to a corresponding one of said cross pieces, wherein a plant growing proximate said central post is attachable to a corresponding one of said strings as the plant grows upwardly.

2. The plant support system of claim 1, further comprising a plurality of clips removably securable to a portion of the plant and one of said strings at a selected position.

3. The plant support system of claim 1, further comprising a plurality of hooks removably securable between first and second portions of the plant.

4. The plant support system of claim 1, wherein said central post comprises at least first and second rods releaseably attached and axially aligned.

5. The plant support system of claim 4, wherein each of said rods includes a first end and a second end having a collar extending outwardly therefrom, said collar forming a bore for receiving said first end of another of said rods so that said rods are releaseably attached to form said central post.

6. The plant support system of claim 1, wherein said first end of each of said cross pieces includes a projection configured for being received in a bore disposed on said second end of said central post.

7. The plant support system of claim 6, wherein said central post includes a collar disposed on said second end of said central post, said collar forming said bore for receiving said projections.

8. The plant support system of claim 7, wherein said bore is configured for receiving first, second and third projections of corresponding first, second and third cross pieces.

9. The plant support system of claim 8, wherein said first, second and third projections align with each other in a cylindrical configuration that is received in said bore.

10. The plant support system of claim 9, wherein said first, second and third projections have identical configurations.

11. The plant support system of claim 1, wherein each of said cross pieces includes at least one opening extending therethrough, said strings securable to said cross pieces through said openings.

12. The plant support system of claim 11, wherein each of said cross pieces includes a plurality of openings.

13. The plant support system of claim 1, wherein each of said cross pieces is arcuate.

14. The plant support system of claim 1, wherein said cross pieces are formed from a material selected from the group consisting of a polymer, a metal, and a rot-resistant wood.

15. The plant support system of claim 1, wherein said central post is formed from a material selected from the group consisting of a polymer, a metal, and a rot-resistant wood.

16. A method of supporting growing plants, comprising the steps of:
providing a plant support system having a central post having a first end and an opposite second, a plurality of cross pieces extending outwardly from the central post second end, and a string secured to each cross piece and extending downwardly therefrom, and a plurality of clips;
inserting the central post first end into the ground intermediate and adjacent at least two plants;
attaching a portion of one of the plants to a fixed position on one string via one of the clips;
attaching a portion of another of the plants to a fixed position on another string via another of the clips;
supporting and maintaining upward growth of the plants by continuously attaching additional portions of the plants to the corresponding strings via additional clips.
